(19) United States
(12) Patent Application Publication
(10) Pub. No.: US 2025/0386820 A1
(43) Pub. Date: Dec. 25, 2025

(54) BIOPOLYMER COMPOSITIONS FOR USE IN AGRICULTURE

(71) Applicant: 11584022 CANADA INC., Montreal (CA)

(72) Inventors: Thomas DI NARDO, Quebec (CA); Francois LAMOUREUX, Quebec (CA)

(73) Assignee: 11584022 CANADA INC., Montreal, QC (CA)

(21) Appl. No.: 18/879,363

(22) PCT Filed: Jun. 29, 2023
(86) PCT No.: PCT/IB2023/056724

§ 371 Date: Dec. 27, 2024

Related U.S. Application Data
(60) Provisional application No. 63/356,679, filed on Jun. 29, 2022.

(51) Int. Cl. A01N 25/10; A01P 21/00

(52) U.S. Cl. CPC A01N 25/10; A01P 21/00

(57) ABSTRACT

Formulations comprising homogeneous suspensions of biopolymer(s) for use the field of agriculture and seed coating compositions comprising a biopolymer are described. In embodiments the biopolymer is selected from chitin, chitosan, cellulose, hemicellulose, lignin, amylose, actin, fibrin, collagen, silk, fibroin, keratin, wool, alginic acid and mixtures thereof. In embodiments the biopolymer is stably dispersed within a polar solvent. The formulations may find particular uses as seed coating, seed soaking, seed pelleting, granular additive (fertilizer), powder additive (fertilizer), root dripping, foliar spray and other agricultural applications.

### CROSS REFERENCE TO RELATED APPLICATION

The present application claims priority to provisional patent application U.S. 63/356,679 (filed Jun. 29, 2022) the content of which is incorporated herein in its entirety.

### FIELD OF THE INVENTION

The invention relates to the field of agriculture, and more particularly to new formulations comprising homogeneous suspensions of biopolymer(s) for use as seed coating, seed soaking, seed pelleting, granular additive (fertilizer), powder additive (fertilizer), root dripping, foliar spray and other agricultural applications.

### BACKGROUND OF THE INVENTION

With climate changes and the growth of the global population, agriculture is now, more than ever, under strong pressure to feed the planet. The agricultural industry is thus permanently searching for ways to improve production and yield, particularly in conditions that are becoming warmer and drier. Pest control is also a major concern.

Seed coating is the application of exogenous materials onto the surface of seeds with the aim of improving seed appearance and handling characteristics (e.g., seed weight and size) and/or delivering active compounds (e.g., plant growth regulators, micronutrients, and microbial inoculants) that can protect the seed. For instance, patent publication US 2011/0039694 describes coating seeds with a composition including a binder, a wax, one or more stabilizer and an optional colorant to facilitate the binding of a bioactive ingredient such as an insecticide or fungicide to the seeds.

Natural polymers, or biopolymers, are polymers that are abundant, natural and renewable. However, most abundant biopolymers such as cellulose and chitin are insoluble, thereby limiting and complicating their use. Advantageously, Applicant has described in WO 2022/137184 new suspensions of biopolymers that are homogeneous and stable. The present inventors have now found that such suspensions of biopolymers may find numerous applications in agriculture.

Accordingly, there is still a need for compositions comprising a biopolymer for agricultural applications such as seed coating.

There is particularly a need for seed coating compositions that can provide benefits such as improving germination rate, increasing water absorption or uptake by the seed, reducing water loss by the seed, allowing germination under dry and/or reduced humidity conditions.

Also, there is still a need for compositions and methods for delivering a bioactive ingredient such as insecticides, fungicides, bacterial inoculants, etc. to seeds and other parts of the plants.

The present invention addresses these needs and other needs as it will be apparent from the review of the disclosure and description of the features of the invention hereinafter.

### BRIEF SUMMARY OF THE INVENTION

According to one aspect, the invention relates to a seed coating composition comprising a biopolymer, the composition comprising biopolymer molecules that have been mechanically processed into a stable homogeneous aqueous suspension.

According to another aspect, the invention relates to a seed coated with a seed coating composition as defined herein.

According to another aspect, the invention relates to the use of a seed coating composition as defined herein for providing at least one of the following benefits, when compared to uncoated seeds: improving germination rate, increasing water absorption or uptake by the seed, reducing water loss by the seed, increasing seedling emergence, allowing germination under reduced humidity conditions, increasing nodule numbers, increasing nitrogen concentration and/or total amount of nitrogen fixation.

According to another aspect, the invention relates to a method of seed coating, comprising applying onto seeds a seed coating composition as defined herein.

According to another aspect, the invention relates to a method of improving germination of a seed during planting comprising coating a seed with a seed coating composition as defined herein.

According to another aspect, the invention relates to a method of improving plant emergence comprising coating a seed to be planted with a coating composition as defined herein.

According to another aspect, the invention relates to a method for coating a seed with a bioactive ingredient, the method comprising applying to the seed a seed coating composition comprising at least one bioactive ingredient stably dispersed in a biopolymer composition.

According to another aspect, the invention relates to a composition for use in agriculture, the composition comprising biopolymer molecules that have been mechanically processed into a stable homogeneous aqueous suspension, e.g., a stable homogeneous aqueous suspension comprising insoluble and/or semi-soluble biopolymer particles stably dispersed within a polar solvent.

Additional aspects, advantages and features of the present invention will become more apparent upon reading of the following non-restrictive description of preferred embodiments which are exemplary and should not be interpreted as limiting the scope of the invention.

### BRIEF DESCRIPTION OF THE DRAWINGS (OR FIGURES)

For the invention to be readily understood, embodiments of the invention are illustrated by way of example in the accompanying drawings.

FIG. 1 is a line graph showing water loss of coated and uncoated seeds, at 35% relative humidity (RH), in accordance with Example 1.

FIG. 2 is a stacked bar graph showing water showing that chitin soybeans coating promotes seedling emergence under water stress conditions, in accordance with Example 2.

FIG. 3 is a panel of pictures showing that chitin soybean seeds coating enhances root hair growth, in accordance with Example.2.

Further details of the invention and its advantages will be apparent from the detailed description included below.

### DETAILED DESCRIPTION OF EMBODIMENTS

In the following description of the embodiments, references to the accompanying figure are illustrations of an example by which the invention may be practised. It will be understood that other embodiments may be made without departing from the scope of the invention disclosed. Unless defined otherwise, all technical and scientific terms used herein have the same meaning as commonly understood by one of ordinary skill in the art to which the invention belongs.

### General Overview

In PCT publication WO 2022/137184 entitled “HOMOGENEOUS BIOPOLYMER SUSPENSIONS, PROCESSES FOR MAKING SAME AND USES THEREOF” (the content of which is incorporated herein by reference in its entirety) Applicant has described the preparation of stable homogeneous suspensions of insoluble and/or semi-soluble biopolymers.

The present invention generally relates to the uses of biopolymers in the manufacture of compositions for use in the agricultural industry and referred herein as “agricultural composition”. Particular aspects concern seed coating, seed soaking, and/or seed pelleting formulations/compositions and methods for using the same. Other aspects concerns the use of biopolymers for other parts of the plants, for instance as a leaf spray or for applying to the roots. Other aspects concerns the use of biopolymers in the manufacture of granular or powder additives (e.g., fertilizer), (fertilizer), root dripping, etc. The present invention encompasses, but is not limited to, general and specific biopolymer compositions described in WO 2022/137184.

### Biopolymer

The agricultural compositions in accordance with the present invention minimally require a biopolymer. As used herein, the term “biopolymer” refers to natural polymers produced by the cells of living organisms. Biopolymers consist of monomeric units that are covalently bonded to form larger molecules. The present invention encompasses polypeptides, polysaccharides and polynucleotides biopolymers. Other examples of biopolymers include natural rubbers (polymers of isoprene), suberin and lignin (complex polyphenolic polymers), cutin and cutan (complex polymers of long-chain fatty acids) and melanin. In embodiments the biopolymers used as starting materials and obtained in the suspensions are substantially pure, i.e., they consist of only purified natural polymers.

Preferably, the biopolymer used in the present agricultural applications is substantially free from chemical residues and any of such chemical residue is absent or present in undetectable or trace amounts. Preferably, the biopolymer is substantially free from chemical residues and any of such chemical residue is absent or present in undetectable or trace amounts. As used herein, “substantially free from chemical residues” means that chemical compounds, such as acids, bases, reactive chemicals, organic salts and/or inorganic salts, surfactants, dispersing agents (e.g., Twin 80™), a silanizing reagent, acrylamide, etc. are totally absent or merely present in undetectable or trace amounts in the final composition or final suspension. In embodiments, the biopolymer(s) will constitute at least 98%, or at least 99% or at least 99.9% or at least 99.99% by weight of the organic compounds in the biopolymer composition or suspension, i.e., the biopolymer composition or suspension will contain less than 2% or less than 1%, less than 0.1%, or less than 0.01%, or less than 0.001% by weight of organic components other than the biopolymer(s) or degradation product(s).

In accordance with the present invention, the biopolymer may be insoluble or semi-soluble in water. As used herein, the term “insoluble biopolymer” refers to a biopolymer that is “insoluble” in a polar solvent (particularly water) and this term encompasses equivalent terms such as “non-water-soluble”, or “not soluble in water”, or “water-insoluble” or “indissoluble”. Insolubility can typically be observed by a separation, i.e., two separate phases in an aqueous mixture, for instance biopolymer deposits/sediments at a bottom or floating at the top of the aqueous mixture. In accordance with the present invention, examples of insoluble biopolymers include, but are not limited to, chitin, chitosan, cellulose, hemicellulose, lignin, amylose, actin, fibrin, collagen, silk, fibroin, keratin, wool, alginic acid and mixtures thereof. As used herein, the term “semi-soluble biopolymer” refers to a biopolymer that may be solubilized in a polar solvent such as water, but under certain conditions (e.g., molecular weight, heat, addition of chemicals such as acids, alcohols, surfactants, etc.). In accordance with the present invention, examples of semi-soluble biopolymers include, but are not limited to gelatin, pectin, starch, amylopectin, agarose, hyaluronic acid, RNA, DNA, xanthan gum, latex, polymannans, suberin, cutin, cutan, and mixtures thereof.

In embodiments the insoluble biopolymer is selected from chitin, chitosan, cellulose, hemicellulose, lignin, amylose, actin, fibrin, collagen, silk, fibroin, keratin, wool, and mixtures thereof. In embodiments the semi-soluble biopolymer is selected from gelatin, pectin, starch, amylopectin, agarose, alginic acid, alginate, hyaluronic acid, RNA, DNA, xanthan gum, guar gum, carrageenan, latex, polymannans, suberin, cutin, cutan, and mixtures thereof.

Various sources of biopolymers may be used and the present invention is not limited to particular sources of materials. For instance, suitable sources of chitin may include, but are not limited to, green plants, algae, and fungi. Suitable sources of chitin and chitosan may include, but are limited to, fungi, crustaceans (e.g. crabs and shrimps) and insects. In embodiments the insoluble or semi-soluble biopolymer is obtained from fungi and mushrooms. In embodiments the insoluble or semi-soluble biopolymer is obtained from plant materials including, but not limited to, roots, tubers, leaves, petals, seeds, fruits, etc.

In embodiments the biopolymer is a 100% natural biopolymer such as SunSpheres Bio™ (microcrystalline cellulose, Dow Chemical), Chemjac™ (amorphophallus konjac root extract and xanthan gum, Chemspire), Kelset™ (sodium alginate, Dupont), Instant Pure-Flo F™ (corn starch, Ingredion), Gelcarin™ GP 379 (carrageenan, iota form, Dupont), Betafib™ MCF (cellulose (and) water-microfibrillated cellulose, Cosun Biobased Products), Betafib™ ETD (cellulose and cellulose gum-microfibrillated cellulose, Cosun Biobased Products), Exilva™ FM02-V,L (cellulose-microfibrillated cellulose, Borregard), Naturesoft™ 800 (cellulose-micro powders), Kelcogel™ CG-HA (gellan gum-CP, Kelco), agar agar, and agarose, mushroom chitosan (e.g., GBS003, Qingdao Chibio Biotech), fungal chitosan (e.g., GBS010, Qingdao Chibio Biotech; or from Kraeber & Co), a fungal derived chitosan (e.g., Kiosmetine-CS™, Kitozyme).

In embodiments the biopolymer is a natural derived biopolymer such as Natrathix™ bio cellulose (cellulose gum, Ashland), Aquasorb™ A500 (cellulose gum, Ashland), Polysurf™ CS 67/Natrosol™ CS plus 330 (cetyl hydroxyethylcellose, Ashland), Structure XL™ (hydroxy propyl starch phosphate, Nouryon), CD-58 (chitosan succinimide, Onlystar Bio-Technology Ltd), carboxymethyl chitosan derivative (GBS010, Qingdao Chibio Biotech), Makimousse™ 7/400 (sodium polyacrylate starch-kobo products, Daito Kasei Kogyo), Salanjul/Sanfresh™ 1000/300sp (sodium polyacrylate starch, Iwase Cosfa USA Inc./Sanyo), Antaron ECoT ethylcellulose (ethyl cellulose, Ashland).

In embodiments the biopolymer comprises a synergistic biopolymer combination, such as Chemjac™ (amorphophallus konjac root extract and xanthan gum, Chemspire), PemuPur™ start (microcrystalline cellulose (and) sphingomonas ferment extract (and) cellulose gum, Lubrizol), Nomcort CG (xanthan gum, Ceratonia siliqua gum, Ikeda).

The biopolymer may also comprise other biopolymer actives such as B-CAN™ 55% (oat beta glucan, Adams Food Ingredients) and/or mushroom derived beta glucan.

The present invention encompasses mixtures of two, three, four, five or more insoluble biopolymers including, but not limited to, chitin+chitosan, chitin+cellulose, chitin+collagen, chitin+silk, chitosan+silk, chitosan+cellulose, chitosan+collagen, cellulose+collagen, cellulose+silk, collagen+silk, etc. The present invention also encompasses mixtures of two, three, four, five or more semi-soluble biopolymers including, but not limited to agarose+DNA, xanthan gum+starch, latex+alginate, xanthan gum+DNA, guar gum+cutan, etc. It may also be envisioned to mix together two, three, four, five or more insoluble and semi-soluble biopolymers including but not limited to chitin+agarose, chitosan+agarose, chitin+gelatin, chitin+xanthan gum, chitosan+xanthan gum, chitin+sodium hyaluronate, chitosan+sodium hyaluronate, cellulose+sodium hyaluronate, chitin+agarose, chitosan+agarose, cellulose+agarose.

The present invention also encompasses combinations of hydrophobically modified biopolymers and unmodified biopolymers which can form stable, viscous oil in water emulsions when dispersed using high shear processes and/or mechanical energy (with or without emulsifiers). Examples of hydrophobically modified biopolymers include Natrosol™ CS Plus 330/Polysurf™ CS 67 (cetyl hydroxyethylcellose, Ashland), StarDesign Ultra™ (sodium starch octenylsuccinate, Cargill Beauty), Inutec™ SP1 (inulin lauryl carbamate, Beneo), Texturlux Stabil™ (hydrolyzed corn starch hydroxyethyl ether, Primient).

In embodiments, the biopolymer consists of a biopolymer composition comprising biopolymer molecules that have been mechanically processed into a stable homogeneous aqueous biopolymer suspension. As used herein the term “homogeneous” generally refers to the appearance of the suspension under the naked eye (e.g., uniform color, uniform texture, etc.). Homogenous as used herein does not exclude the possibility that the suspension is “heterogenous” at the molecular level (e.g., various particles size, presence of aggregates, etc.). As used herein, the terms “stable homogeneous aqueous biopolymer suspension”, or similar terms that may be used herein interchangeably such as “homogenous biopolymer suspension” or “stable biopolymer suspension” or simply “biopolymer suspension”, all refer to a suspension of insoluble and/or semi-soluble biopolymer particles that have been stably dispersed within a polar solvent. The polar solvent may be a polar protic solvent or a polar aprotic solvent. The polar solvent may be an aqueous solvent. The insoluble and/or semi-soluble biopolymer particles that are present in biopolymer suspensions may be shaped like fibers and/or like agglomerated spheres or agglomerated bodies. Stability of the biopolymer suspensions may be assessed by any suitable means. In preferred embodiments, the stability is measured or observed by a lack of separation, i.e., one single phase instead of two separate phases in an aqueous mixture, for instance absence of biopolymer deposits/sediments at a bottom or floating at the top of the aqueous mixture. Preferably, biopolymer suspensions in accordance with the present invention are stable (e.g., absence of separation) for at least 1 day, or at least 1 week, or at least one month, or at least one year or more.

Notwithstanding the above, those skilled in the art understand that insoluble and/or semi-soluble biopolymers may never become truly soluble. Instead, they become “swellable” and bind water which is why the biopolymer becomes a viscous suspension during the high-shearing conditions and/or mechanical energy to which the biopolymer(s) are submitted in accordance with the present invention. Accordingly, the present invention encompasses both, “swellable biopolymers” as well as “non-swellable biopolymers” since a non swellable polymer could be swellable using high-shearing and/or mechanical energy. As used herein, swellable biopolymers encompasses biopolymers that absorb and bind water, which results in an increase in their particle size and water dispersion viscosity.

In embodiments, the biopolymer is swellable with wet ball milling. This may include, but it is not limited to, chitin, chitosan, hemicellulose and pregelatinized corn starch.

In embodiments, the biopolymer is swellable with high shear processes other than ball milling. This may include, but it is not limited to, microcrystalline cellulose, microfibrillated cellulose, nano cellulose, hairy nanocellulose, konjac glucomannan, hydroxypropyl starch phosphate, high acyl gellan gum, gellan gum, carboxymethyl starch, carboxymethyl cellulose (low ds type), agar agar, and agarose.

It is also conceivable in accordance with the present invention to use soluble biopolymers including, but not limited to, xanthan gum, diutan gum, sodium alginate, sclerotium gum.

In embodiments, the biopolymer molecules or particles that are part of the agricultural composition have been mechanically processed into a stable homogeneous aqueous biopolymer suspension. In embodiments the mechanical processing involves high-shearing conditions and/or high mechanical energy. In embodiments the high-shearing conditions and/or high mechanical energy is obtained by a process including, but not limited to mechanical shearing, shear thinning, planetary ball milling, rolling mill, vibrating ball mill, tumbling stirred ball mill, horizontal media mill, colloid milling. As indicated hereinafter, the high-shearing conditions and/or high mechanical energy can be carried out for a duration, under parameters, under suitable conditions, etc. until a desirable change of state is obtained, e.g., change of color, a change in viscosity, a change from a slurry to a paste, ointment, cream, lotion, gel or milk, etc.

Without wishing to be bound by theory, submitting the biopolymer to high-shearing conditions and/or high mechanical energy improves biopolymer performance not seen using conventional processes, including improved rheological properties such as viscosity, shear thinning properties, and high yield value. biopolymers dispersed using high shear processes may contain lamellar crystalline gel networks (LGN) that may synergistically increase the viscosity of the biopolymer dispersions. Oil+water biopolymer dispersions in accordance with the present invention may also contain Pickering emulsion wherein the water-in-oil or oil-in-water emulsion is stabilized by the biopolymer.

In embodiments the high-shearing conditions and/or high mechanical energy requires using a suitable device or apparatus including, but not limited to, ball miller (e.g., planetary ball miller, rolling miller, vibrating ball miller, tumbling stirred ball miller, horizontal media mill, colloid miller, a magnetic miller), a twin-screw extruder, a high-pressure homogenizer, a blade homogenizer, a stirring homogenizer, a disperser, a rotor-stator homogenizer, a high-shear mixer, a plowshare mixer, a dynamic mixer, a plough mixer, a turbine mixer, a speed mixer, an attrition miller, a sonicator (e.g. high shear ultrasonic processes), a tissue tearor, a cell lysor, a polytron, a ribbon agitator, a microfluidizer, a high pressure homogenizer, and combinations thereof. In preferred embodiments, the present invention utilizes ball milling under wet conditions. Particular examples of ball miller include, but are not limited to, vertical planetary mill (e.g., Tencan XQM-2A™) with 100 ml capacity zirconia jars and 10 mm diameter zirconia balls, Flacktek™ speed mixer (DAC 330-11 SE) with 40 mL zirconia jar with 5 mm diameter zirconia balls or zirconia rings and 1.5 L Supermill Plus™ with 1.4-1.7 mm zirconia beads and Netzsch mill Labstar™ with 0.6-0.8 mm beads or 1.4-1.7 mm beads.

In particular embodiments, biopolymer compositions and suspensions in accordance with the present invention are obtained using a particular protocol referred herein as the “10+1 Alt method”. This method comprises milling of the biopolymer for a certain period of time (e.g., 10 min) followed by a short pause (e.g., 1 min) then milling in the opposite direction for a certain period of time (e.g., 10 min) for a total of 1 hour, or 2 hours, or 3 hours, or 5 hours, 10 hours, or 12 hours.

Advantageously, the viscosity of the compositions/suspensions can be altered by varying the high-shearing conditions and/or mechanical energy to which the biopolymer(s) are submitted. These conditions can be adjusted to obtain a stable homogeneous suspension (e.g., a stable colloidal homogeneous suspension) having a desired viscosity. Typically, providing more mechanical energy will increase the shearing and will reduce accordingly the viscosity of the end product. The biopolymer itself and/or the final agriculture-related compositions may be formulated as a paste, an ointment, a cream, a lotion, a gel or a milk of a desired viscosity (e.g. coating suspension with low, medium or high viscosity).

In embodiments, the biopolymer, and/or the biopolymer compositions comprising biopolymer molecules or particles is a colloidal homogeneous biopolymer suspension. In embodiments, the colloidal homogeneous suspension comprises colloids having a range from about 1 nm to about 1 μm.

In embodiments, the biopolymer, and/or the biopolymer compositions comprising biopolymer molecules, comprises biopolymer fibers. In embodiments the fibers have of a width of about 1 nm to about 5 μm, or about 5 nm to about 5 μm, about 7 nm to about 5 μm, or about 10 nm to about 5 μm, or about 20 nm to about 5 μm, or about 25 nm to about 5 μm, or about 30 nm to about 5 μm, or about 35 nm to about 5 μm, or about 35 nm to about 3 μm. In embodiments the fibers having of a width of at least 1 nm, or at least 5 nm, or at least 10 nm, or at least 20 nm, or at least 30 nm, or at least 40 nm, or at least 50 nm, or at least 75 nm, or at least 100 nm, or at least 250 nm, or at least 500 nm, or at least 750 nm, or at least 1 μm, or at least 2 μm, or at least 3 μm, or at least 4 μm, or at least 5 μm, or wider.

In embodiments the biopolymer, and/or the biopolymer compositions comprising biopolymer molecules, comprises biopolymer fibers having a length of about 1 nm to about 200 μm, of about 10 nm to about 100 μm, or about 50 nm to about 10 μm, or about 100 nm to about 10 μm, or about 500 nm to about 10 μm, or about 750 nm to about 10 μm, or about 800 nm to about 10 μm, or about 900 nm to about 5 μm, or about 1 μm to about 10 μm, or about 1 μm to about 5 μm, or about 1 μm to about 3 μm. In embodiments the fibers have of a length of at least 1 nm, or at least 10 nm, at least 50 nm, or at least 100 nm, or at least 250 nm or at least 500 nm, or at least 750 nm, or at least 800 nm, or at least about 900 nm, or at least 1 μm, or at least 2 μm, or at least 3 μm, or at least 4 μm, or at least 5 μm, or at least 6 μm, or at least 7 μm, or at least 8 μm, or at least 9 μm, or at least 10 μm, or at least 25 μm, or at least 50 μm, or at least 75 μm, or at least 100 μm, or at least 150 μm, or at least 200 μm or longer. In embodiments, a dry particle size range may be between about 1 nm to about 1 μm, or up to 10 μm, and a wet particle size range may be between about 200 nm to about 20 μm, or up to 200 μm.

In embodiments the biopolymer, and/or the biopolymer compositions comprising biopolymer molecules, comprises biopolymer fibers having both: (i) a width greater than 20 nm (e.g., at least 25 nm, or at least 40 nm, or at least 50 nm,) and a length greater than 50 nm (e.g., at least 100 nm, or at least 500 nm, or at least 1 μm, or at least 2 μm); or (ii) a width greater than 32 nm (e.g., at least 35 nm, or at least 40 nm, or least 50 nm) and a length of than 50 nm (e.g., at least 100 nm, or at least 500 nm, or at least 1 μm, or at least 2 μm); or (iii) a width greater than 20 nm (e.g., at least 25 nm, or at least 40 nm, or least 50 nm) and a length of than 500 nm (e.g., at least 600 nm, or at least 750 nm, or at least 1 μm, or at least 2 μm); or (iv) a width greater than 30 nm (e.g., at least 35 nm, or at least 40 nm, or least 50 nm) and a length of than 800 nm (e.g., at least 900 nm, or at least 1 μm, or at least 2 μm); or (v) a width greater than 8 nm (e.g., at least 10 nm, at least 25 nm, or at least 35 nm, or at least 40 nm, or least 50 nm) and a length of than 340 nm (e.g., at least 350 nm, or at least 500 nm, at least 750 nm, or at least 900 nm, or at least 1 μm, or at least 2 μm); or (vi) a width greater than 11 nm (e.g., at least 15 nm, at least 25 nm, or at least 35 nm, or at least 40 nm, or least 50 nm) and a length of than 166 nm (e.g., at least 200 nm, or at least 350 nm, or at least 500 nm, at least 750 nm, or at least 900 nm, or at least 1 μm, or at least 2 μm); or (viii) a width greater than 32 nm (e.g., at least 35 nm, or at least 40 nm, or least 50 nm) and a length greater than 800 nm (e.g., at least 900 nm, or at least 1 μm, or at least 2 μm, or at least 3 μm, or at least 4 μm, or at least 5 μm, or at least 6 μm, or at least 7 μm, or at least 8 μm, or at least 9 μm, or at least 10 μm, or at least 25 μm, or at least 50 μm, or at least 75 μm, or at least 100 μm, or at least 150 μm, or at least 200 μm or longer).

In embodiments the biopolymer, and/or the biopolymer compositions comprising biopolymer molecules, comprises biopolymer fibers wherein the average width and average length of the fibers in the composition are as defined hereinabove, e.g. an average width greater than 20 nm (e.g., at least 25 nm, or at least 40 nm, or at least 50 nm) and an average length greater than 50 nm (e.g., at least 60 nm, at least 75 nm, or at least 100 nm, or at least 500 nm, at least 750 nm, or at least 1 μm, or at least 2 μm, or at least 3 μm, or at least 4 μm, or at least 5 μm, or at least 6 μm, or at least 7 μm, or at least 8 μm, or at least 9 μm, or at least 10 μm, or at least 25 μm, or at least 50 μm, or at least 75 μm, or at least 100 μm, or at least 150 μm, or at least 200 μm or wider).

In embodiments the biopolymer suspensions and/or biopolymer compositions comprising biopolymer molecules, have a pH between about 6.5 and about 8.5. In particular embodiments the biopolymer suspension is a chitosan suspension having a pH between about 7.8 and about 8.1.

In embodiments the biopolymer, and/or the biopolymer compositions comprising biopolymer molecules, comprises biopolymer fibers having both a crystalline region and an amorphous region. In embodiments the stable homogeneous suspension comprises biopolymer fibers having a globular shape. In embodiments the stable homogeneous suspension is comprised of mainly, or only, of suspended biopolymer nanofibrils.

Those skilled in the art are aware that particle size measurements may vary according to the measurement method and the state of the particles (e.g., particles in a wet state are typically larger than the same particles in a dry state). Typically, the particles will be in a wet or suspended stage when measured by dynamic light scattering (DLS) and in a dry stage when measured by scanning electron microscopy (SEM).

In embodiments the biopolymer, and/or the biopolymer compositions comprising biopolymer molecules, comprises agglomerated spheres of alginic acid having an average size of about 40 nm to about 80 nm, or about 45 nm to about 75 nm, as measured by scanning electron microscopy (SEM). In embodiments, the stable homogeneous suspension comprises agglomerated spheres of alginic acid having a median size of about 30 nm to about 70 nm or about 35 nm to about 65 nm, average size of about 40 nm to about 80 nm, or about 45 nm to about 75 nm, as measured by scanning electron microscopy (SEM).

In embodiments the biopolymer, and/or the biopolymer compositions comprising biopolymer molecules, comprises agglomerated spheres of cellulose having an average size of about 50 nm to about 80 nm, or about 55 nm to about 75 nm, average size of about 40 nm to about 80 nm, or about 45 nm to about 75 nm, as measured by scanning electron microscopy (SEM). In embodiments the stable homogeneous biopolymer suspension comprises agglomerated spheres of cellulose having a median size of about 35 nm to about 75 nm or about 40 nm to about 65, average size of about 40 nm to about 80 nm, or about 45 nm to about 75 nm, as measured by scanning electron microscopy (SEM).

In embodiments the biopolymer, and/or the biopolymer compositions comprising biopolymer molecules, comprises agglomerated spheres of chitin having an average size of about 45 nm to about 85 nm, or about 50 nm to about 80 nm. In embodiments the stable homogeneous biopolymer suspension comprises agglomerated spheres of cellulose having a median size of about 45 nm to about 80 nm or about 50 nm to about 75 nm, as measured by scanning electron microscopy (SEM).

In embodiments the biopolymer, and/or the biopolymer compositions comprising biopolymer molecules, comprises agglomerated spheres of chitosan having an average size of about 75 nm to about 120 nm, or about 80 nm to about 115 nm, or about 85 nm to about 110 nm, as measured by scanning electron microscopy (SEM). In embodiments the stable homogeneous suspension comprises agglomerated spheres of chitosan having a median size of about 70 nm to about 100 nm or about 75 nm to about 95 nm, as measured by scanning electron microscopy (SEM).

In embodiments the biopolymer, and/or the biopolymer compositions comprising biopolymer molecules, comprises agglomerated spheres of silk having an average size of about 40 nm to about 165 nm, or about 45 nm to about 160 nm, as measured by scanning electron microscopy (SEM). In embodiments the stable homogeneous biopolymer suspension comprises agglomerated spheres of silk having a median size of about 40 nm to about 150 nm or about 45 nm to about 140, as measured by scanning electron microscopy (SEM).

In embodiments the biopolymer, and/or the biopolymer compositions comprising biopolymer molecules, comprises particles of one or more of alginic acid, cellulose, chitin, chitosan and silk, wherein the range of particle sizes, as measured by SEM is as defined in the tables and figures of WO 2022/137184.

In embodiments the biopolymer, and/or the biopolymer compositions comprising biopolymer molecules, is (are) characterized by visual properties like those depicted in the SEM images shown in the figures of WO 2022/137184.

In embodiments the biopolymer, and/or the biopolymer compositions comprising biopolymer molecules, is (are) characterized by a Fourier Transform Infrared Spectroscopy (FTIR) spectrum as depicted in the figures of WO 2022/137184.

In embodiments the biopolymer, and/or the biopolymer compositions comprising biopolymer molecules, is (are) characterized by Solid-State Nuclear Magnetic Resonance characterization (SSNMR) as depicted in the figures of WO 2022/137184.

In embodiments the biopolymer, and/or the biopolymer compositions comprising biopolymer molecules, is (are) characterized by Power X-Ray Diffraction (PXRD) pattern(s) as depicted in the figures of WO 2022/137184.

In embodiments the biopolymer, and/or the biopolymer compositions comprising biopolymer molecules, is (are) characterized by Dynamic Light Scattering (DLS) measurements like those reported in WO 2022/137184.

In embodiments the biopolymer, and/or the biopolymer compositions comprising biopolymer molecules, is (are) characterized by a transmittance spectrum as shown in the figures of WO 2022/137184.

In embodiments the biopolymer, and/or the biopolymer compositions comprising biopolymer molecules, is (are) characterized by a sweep suspension test as reported in WO 2022/137184.

In embodiments the biopolymer, and/or the biopolymer compositions comprising biopolymer molecules, is (are) characterized by a rheological behaviour as depicted in the figure(s) s of WO 2022/137184.

### Seed Coating Compositions+Compositions for Other Parts of the Plant

One particular aspect of the present invention concerns seed coating formulations/compositions that comprise biopolymers and/or the biopolymer. Additional aspects of the present invention concerns formulations/compositions that comprise biopolymers and/or the biopolymer compositions as defined herein that can be used and/or applied to other parts of the plant (e.g., roots, tubers, leaves, petals, seeds, fruits, etc.). Typically, unless of conflicting evidence, reference to “seed coating composition” below typically applies to compositions for agricultural uses in general, including formulations/compositions for other parts of the plants.

In embodiments, the seed coating composition comprises biopolymer molecules that have been mechanically processed into a stable homogeneous aqueous suspension. In embodiments, the stable homogeneous aqueous suspension comprises insoluble and/or semi-soluble biopolymer particles. In embodiments, the biopolymer consists of a stable homogeneous aqueous suspension composed of insoluble and/or semi-soluble biopolymer particles. In embodiments, the insoluble and/or semi-soluble particles are stably dispersed within a polar solvent.

The seed coating composition may further comprise additional compounds or substance including, but not limited to, a safener, a binder, a wax, a stabilizer, a humectant, a colorant, etc.

The seed coating composition may further comprise a bioactive agent including, but not limited to, a fungicide, an insecticide, a bacteria, a biopeptide, a nitrogen fixer, low molecular weight biopolymers, oligomers, etc.

Examples of insecticides include, but are not limited to, imidacloprid, clothianidin, Chlorpyrifos, Organochlorine, Organophosphate, Organosulfur, Carbamates, Formamidines, Dinitrophenols, Organotins, Pyrethroids, Nicotinoids, Spinosyns, Pyrazoles, Pyridazinones, Quinazolines, Botanicals, Synergists/Activators, Antibiotics, Fumigants, Inorganics, Biorational, Benzoylureas, Permethrin (pyrethroid), Esfenvalerate (pyrethroid), Bacillus thuringiensis (BT—Biologicals), Diazinon (organophosphate), Methomyl (carbamate), Malathion (organophosphate), pyrethrin (botanical), Carbaryl (N-methyl carbamate), Endosulfan (organochlorine), Beta-cyfluthrin (pyrethyroid), Carbaryl (carbamate), Chlorpyrifos (organophosphate), Cyfluthrin (pyrethroid), Dimethoate (organophosphate), Gama-cyhalothrin (pyrethroid), Idoxacard™ (carboxylate), Methomyl™ (carbamate), Methyl Parathion™ (organophosphate), Permethrin™ (pyrethroid), Phosmet™ (organophosphate), Spinosad™ (fermentation product), Zeta-cypermethrin (pyrethroid), Beta-cyfluthrin (pyrethyroid), Carbaryl (carbamate), Chlorpyrifos (organophosphate), Deltamethrin (pyrethroid), Dimethoate (organophosphate), Esfenvalerate (pyrethroid), Gama- and Lambda-cyhalothrin (pyrethroid), Malathion (organophosphate), Methidathion (organophosphate), Methomyl (cyclodine), Sevin™ (carbaryl), Imidan™ (phosmet), Kelthane™ (dicofol), Guthion™ (azinphos methyl), Vendex™ (hexakis fenbutatin-oxide), Lanate™ (methomyl), Methoxychlor (methoxychlor), Provado™ (imidacloprid), Thiodan™ (endosulfan), Malathion™, Neemix™, Pyrethrins™, Cygon 400™ (dimethoate), Cythion™ 57% (malathion), Diazinon™ AG500 (organophosphate), Dibrom™ 8E, Dipel™ 2X, Imidan™ 50 WP, Lannate L,™ Lorsban™ 15 G, Metasystox-R™, Parathion™ 4E, Thiodan™ 3E, Zolone™ 3EC, Acramite™ (bifenazate), Baythroid™ (cyfluthrin), Dimilin™ (diflubenzuron), Fulfill™ (pymetrozine), MSR™ (oxydemeton-methyl), Temik™ (aldicarb), Venom™ (dinotefuran), Zeal™ (etoxazole), Asana™ XL (esfenvalerate), Baythroi™ d 2 (cyfluthrin), Cruiser™ 5FS (thiamethoxam), Dimethoate™ 4E (organophosphate), Gaucho™ 480 (imidacloprid), Lorsban™ 4E (chlorpyrifos), Mustang™ Max (pyrethroid), Nufos™ 4E (chlorpyrifos), Warrior™ (organophosphate).

Examples of fungicides include, but are not limited to, Vibrance™ Maxx RFC by Syngenta, Actino-Iron® (Streptomyces lydicus WYEC), Actinovate™ AG (Streptomyces lydicus), Agclor™ 310 (sodium hypochlorite), Affirm™ WDG (polyoxin-D), Agri-Fos™ (phosphorus acid), Agri-mycin™ 17 (streptomycin sulfate), Aliette™ WDG (fosetyl Al), Alude™ (phosphorous acid), Apron™ XL (mefenoxam), Aprovia™ Top (benzovindiflupyr+difenoconazole), Ariston™ (chlorothalonil+cymoxanil), BadgeX2® SC (copper oxychloride+copper hydroxide), Basic Copper 53® (basic copper sulfate), Bio-Save 10 LP® (Pseudomonas syringae ESC-10), Bio-Tam® (Trichoderma aperellum, T. gamsii), Blocker™ 4F (PCNB), BotryStop® (Ulocladium oudemansii U3 Strain), Bumper™ (propiconazole), Bravo™ (Weather Stik, Ultrex, ZN) (chlorothalonil), Cabrio™ EG (pyraclostrobin), Cabrio™ Plus (pyraclostrobin+metiram), Camelot O® (copper soap), Cannonball™ WG (fludioxonil), Catamaran™ (potassium phosphite+chlorothalonil), Cease® (Bacillus subtilis QST 713), Champ WG® (copper hydroxide), Champ™ Dry Prill (copper hydroxide), Champ™ Formula 2 Flowable (copper hydroxide), ChampION++™ (copper hydroxide), Companion® (Liquid, WP) (Bacillus subtilis strain GB03), Contans WG® (Coniothyrium minitans), Cuprofix™ Ultra 40 Disperss (basic copper sulfate), Cuproxat™, Cuproxat FL® (basic copper sulfate), Curzate 60 DF (cymoxanil), Custodia (azoxystrobin+tebuconazole), DiTera DF® (Myrothecium verrucaria Strain AARC-0255), Dithane™ (M-45, F-45 Rainshield™) (mancozeb), Decree 80 WDG (fenhexamid), Double Nickel® 55 and LC (Bacillus amyloliquefaciens), Dynasty™ (azoxystrobin), Echo™ (90DF, 720) (chlorothalonil), EcoSwing® (extract of Swinglea glutinosa), Emblem™ (fludioxonil), Endura™ (boscalid), Equus™ 720 SST (chlorothalonil), Flint™ (trifloxystrobin), Fontelis™ (penthiopyrad), Forum™ (dimethomorph), Fosphite™ (phosphorus acid), Gavel™ (75 DS, DF) (zoxamide+mancozeb), GEM 500 SC™ (trifloxystrobin), Headline™, Headline SC™ (pyraclostrobin), Headline AMP™ (pyraclostrobin+metconazole), Incognito™ (4.5 F, 85 WDG) (thiophanate-methyl), Initiate™ (720, ZN) (chlorothalonil), Inspire Super™ (difenoconazole+cyprodinil), Iprodione 4L AG (Iprodione), JMS Stylet-Oil®, JMS Stylet-Oil™ (paraffinic oil), Kaligreen® (potassium bicarbonate), Kalmor® (copper hydroxide), Kentan™ DF (copper hydroxide), K-Phite™ 7LP (phosphorus acid), Kocide™ 2000, Kocide 2000-O®, Kocide™ 3000, Kocide™ 3000-O® (copper hydroxide), Kumulus DF® (sulfur), Luna Experience™ (fluopyram+tebuconazole), Luna Sensation™ (fluopyram+trifloxystrobin), Luna Tranquility™ (fluopyram+pyrimethanil), ManKocide™ (copper+mancozeb), Manzate™ (Max, Pro-Stick) (mancozeb), MasterCop™ (copper sulfate pehtahydrate), Maxim™ 4FS (fludioxonil), Maxim™ MZ (fludioxonil+mancozeb), Maxim™ PSP (fludioxonil), Merivon™ (fluaxapoxad+pyraclostrobin), Mertect™ 340-F (thiabendazole), Micora™ (mandipropamid), Microthiol Disperss® (sulfur), Microfine™ Sulfur (sulfur), Micro Sulf® (sulfur), Mildew Cure® (cottonseed, corn, and garlic oils), MilStop® (potassium bicarbonate), M-Pede® (insecticidal soap), Moncoat™ MZ (flutolanil+mancozeb), Moncut™ 70 DF (flutolanil), Mural™ (azoxystrobin & benzovindiflupyr), MycoStop® (Streptomyces griseoviridis K61), Nevado™ (Iprodione), Nordox™ 75 WG® (cuprous oxide), Nu-Cop™ (3 L, 50DF®, 50WP®, HB®) (copper hydroxide), Nutrol™ (potassium dihydrogen phosphate), Nufarm™ T-Methyl 70WSB, 4.5F (thiophanate-methyl), Obtego® (Trichoderma aperellum, T. gamsii), Omega™ 500 (fluazinam), Omega™ Top MP (fluazinam), Organocide® (sesame oil), Orius™ (3.6F) (tebuconazole), Orondis Opti™ (chlorothalonil+oxathiapiprolin), Orondis Opti B™ (chlorothalonil), Orondis™ (Ultra A, Gold 200, Opti A) (oxathiapiprolin), Orondis Ultra™ (oxathiapiprolin+mandipropamid), Orondis Ultra B™ (mandipropamid), OSO™ 5% SC (polyoxin D), OxiDate 2.0® (hydrogen dioxide+peroxyacetic acid), OxiPhos™ (phosphorus acid+hydrogen peroxide), Pageant Intrinsic™ (pyraclostrobin+boscalid), Penncozeb™ (75DF, 80WP) (mancozeb), PhD™ (polyoxin D), Phyton™ 35 (copper sulfate), Phostrol™ (phosphorus acid), Polyram™ 80 DF (metiram), Potato Seed Treater™ 6% (mancozeb), PreFence® (Streptomyces griseoviridis K61), Presidio™ 4SC (fluopicolide), PreStop® (Gliocladium catenulatum J1446), Previcur Flex™ (propamocarb), Priaxor™ (fluxapyroxad+pyraclostrobin), Pristine™ (boscalid+pyraclostrobin), PVent® (Gliocladium catenulatum J1446), Procure™ (triflumizole), Proline™ 480SC (prothioconazole), ProPhyte™ (phosphorus acid), PropiMax™ EC (propiconazole), Quadris™ (azoxystrobin), Quadris Opti™ (azoxystrobin+chlorothalonil), Quadris Ridomil Gold™ (azoxystrobin+mefenoxam), Quadris Top™ (azoxystrobin+difenaconazole), Quash™ (metraconazole), Quilt™ (azoxystrobin+propiconazole), Quilt Xcel™ (azoxystrobin+propiconazole), Quintec™ (quinoxyfen), Rally™ 40 SWP (myclobutanil), Rampart™ (phosphorus acid), Ranman™ (cyazofamid), Reason™ 500 SC (femadione), Regalia® (extract of Reynoutria sachalinensis), Reville™ (phosphorus acid), Resist™ (phosphorus acid), Revus™ (mandipropamid), Revus Top™ (mandipropamid+difenoconazole), Rhyme™ (flutriafol), Ridomil Gold™ (4SL, GR) (mefenoxam), Ridomil Gold Bravo SC™ (mefenoxam+chlorothalonil), Ridomil Gold MZ 72™ (mefenoxam+mancozeb), Ridomil Gold Copper™ (mefenoxam+copper), RootShield™ AG, WP® (Trichoderma harzianum Rifai strain KRL-AG2), RootShield Granules® (Trichoderma harzianum Strain T-22), RootShield Plus WP™, Granules® (Trichoderma harzianum Strain T-22+T. virens Strain G-41), Roper (DF™, DF Rainshield™) (mancozeb), Rovral™ 4 F (iprodione), Scala™ SC (pyrimethanil), Serenade™ (ASO®, Opti®) (Bacillus subtilis QST 713), Sil-MATRIX® (potassium silicate), Sonata® (Bacillus pumilus QST 2808), Sovran 50 WG™ (kresoxim-methyl), Spirato™ (fludioxonil), Sporan™ EC (rosemary, clove, and thyme oils), Stargus® (Bacillus amyloliquefaciens F727), Stratego™, Stratego YLD™ (propiconazole+trifloxystrobin), Subdue MAXX™ (Mefenoxam), Suffoil-X® (petroleum oils), Sulfur 6L™ (sulfur), Super Tin™ 80 WP (triphenyltin hydroxide), Switch™ 62.5 WG (cyprodinil+fludioxonil), Taegro 2™ (B. subtilis var. amyloliquefaciens FZB24), Tanos 50 DF™ (famoxadone+cymoxanil), Terraclor™ 400 (PCNB), Tilt™ (propiconazole), Topguard™ (flutriafol), Topguard™ EQ (azoxystrobin+flutriafol), Topsin™ (4.5FL, M 70 WSB) (thiophanate-methyl), Torino™ (cyflufenamid), Triathlon™ BA (Bacillus amyloliquefaciens D747), Trilogy® (neem oil), Trionic™ 4SC (triflumazole), Trivapro™ (benzovindiflupyr+azoxystrobin+propiconazole), Ultra Flourish™ (mefenoxam), Vanguard™ WG (cyprodinil), Vivando™ (metrofenone), ZeroTol 2.0® (hydrogen dioxide), Zampro™ 525SC (ametoctradin+dimethomorph), Ziram™ (76DF, Excel) (ziram), Zing!™ (zoxamide).

Examples of bacteria include, but are not limited to, Bacillus subtilis, Bacillus thurigiensis, Burkholderia, Pseudomonas, Enterobacter, Klebsiella, Serratia, Alcaligenes, Arthrobacter, Delftia acidovorans (e.g. Lalfix Proyield™ liquid soybeaninoculant by Lallemand). Additional examples may be found in U.S. Pat. No. 9,333,227 which describes genetically engineered microbial cells that can produce bacteriocin, and U.S. Pat. Nos. 9,868,675 and 10,053,392 which describe a consortium of bacteria strains for enhancing the availability of soil phosphorous and other macronutrients to plants.

Examples of biopeptides include, but are not limited to, Thuricin 17 (see PCT patent publication WO 2008/138129), Bacillin 20 (a peptide produced by a Bacillus thuringiensis), colicins, microcins, pyocins, carocin S1, carotovoricins, glycinecin, putidacin, ipomicin, Michiganin A, surfactins, iturins and fengycins.

Examples of nitrogen fixers include, but are not limited to, blue green algae (cyanobacteria (e.g., Oscillatoria, Gloeocapsa, Lyngbya, Plectonema), lichens, free-living soil bacteria, Azotobacter, Anabaena, Nostoc, Beijerinckia, Clostridium, Rhizobium, Bradyrhizobium elkanii, Azospirillum, Chlorobium, Chromatium, Azomonas, Derxia, Rhodospirillum, Desulfovibro, Rivularia, Calothrix, Pullularia.

### Desirable Properties

The seed coating compositions in accordance with the present invention are preferably stable. Stability at least means that the biopolymer (e.g., fibers, spherical bodies) and/or any other component of the compositions, does not settle at the bottom. In embodiments the insoluble and/or semi-soluble biopolymer(s) remains in suspension for at least 1 week, or at least 1 month, or at least 6 months, or at least 12 months, or at least 18 months, or at least two years, or at least three years or more.

The seed coating compositions in accordance with the present invention may be formulated to have a desired viscosity (e.g., viscosity of what is generally referred to as a paste, an ointment, a cream, a lotion, a gel or a milk). In embodiments the viscosity of the compositions/suspensions can be altered by varying the high-shearing conditions and/or mechanical energy to which the biopolymer(s) are submitted. In embodiments the stable homogeneous suspension comprises a viscosity of about 25 mPa to about 85 000 mPa. Table 1 below provides non-limiting examples of desirable viscosity for the compositions/suspensions in accordance with the present invention.

TABLE 1
Examples of desired viscosities

| Desired Consistency | Exemplary viscosity (mPa · s) |
|---|---|
| paste | about 40 000 to about 200 000 or higher |
| ointment | about 20 000 to about 50 000 |
| cream | about 1 500 to about 30 000 |
| lotion | about 800 to about 4 000 |
| gel | about 1 000 to about 40 000 |
| milk | about 20 to about 2000 |

In embodiments, the viscosity the seed coating compositions in accordance with the present invention may be varied by selecting accordingly additional ingredients (e.g., safener, binder, wax, a stabilizer, humectant, colorant, bioactive agent, etc.).

The viscosity the seed coating compositions in accordance with the invention may also be varied in accordance with the ratios or concentration of each of the compound entering into the composition, in addition to the biopolymer. In embodiments the weight ratio of biopolymers: other components (e.g., safener, binder, wax, a stabilizer, humectant, colorant, bioactive agent, etc.) is of about 0.1:20 to about 10:20, or about 0.5:20 to about 3:20, or about 0.75:20, or about 1.0:20, 1.25:20. or about 1.5:20.

In embodiments the composition in accordance with the invention comprises about 0.01-10% w/w of biopolymer, or 0.01-5% w/w of biopolymer, or 0.01-2% w/w of biopolymer, or 0.01-1% w/w of biopolymer. In embodiments the composition in accordance with the invention comprises about 0.01% w/w of biopolymer, or about 0.05% w/w of biopolymer, or about 0.1% w/w of biopolymer, or about 0.25% w/w of biopolymer, or about 0.5% w/w of biopolymer, or about 0.75% w/w of biopolymer, or about 1% w/w of biopolymer, or about 1.5% w/w of biopolymer, or about 2.5% w/w of biopolymer, or about 5% w/w of biopolymer.

Agricultural compositions in accordance with the invention may also be provided in a dried form and formulated as a powder, pellets, granules, films, rods etc. Dried forms may be useful for applications such as leaf spraying and/or for producing slow-release formulations to the roots or seeds (e.g. granules to release bioactive and/or granules allowing to retain and release humidity/water to the plant. Compositions in a dry form may be obtained by preparing a biopolymer composition as defined herein or, optionally by: (i) preparing a mixture comprising an active ingredient mixed into biopolymer composition; (ii) drying the mixture to obtain a dried product; and optionally, forming a powder, pellets, granules, films and/or rods with the dried product. For powder, the suspension composition could be spray-dried into powder form. The powder could be compressed into pellets. The suspension could also be dried into as large droplets to form pellets or can be refined into granules.

### Methods of Manufacture

Another aspect of the present invention concerns methods of manufacturing agricultural compositions as defined herein.

In one embodiment, obtaining the agricultural composition comprises subjecting an insoluble and/or semi-soluble biopolymer to mechanical energy in presence of a polar solvent to obtain a stable homogeneous suspension of the insoluble and/or semi-soluble biopolymer(s). That stable homogeneous suspension may serve as a seed coating composition and/or other agricultural uses in general, including formulations/compositions for other parts of the plants.

In one embodiment, obtaining the agricultural composition comprises mixing at least one bioactive agent into a stable homogeneous aqueous comprising insoluble and/or semi-soluble biopolymer particles. As mentioned hereinbefore, the bioactive agent may be selected from a fungicide, an insecticide, a bacteria, a biopeptide, a nitrogen fixer and mixtures thereof.

In embodiments, manufacturing the agricultural composition comprises mechanically processing together the at least one bioactive agent with biopolymer(s) under high-shearing conditions and/or high mechanical energy to obtain a stable homogeneous aqueous composition as defined herein, the composition comprising insoluble and/or semi-soluble biopolymer particles, with the bioactive agent(s) dispersed therein. Preferably any bacteria would be added subsequently to the preparation of the biopolymer suspension.

In embodiments, manufacturing the agricultural composition comprises mixing additives (e.g., bioactive agent(s)) to a pre-made biopolymer suspension.

### Uses in Agriculture and Potential Benefits

The compositions with the present invention may find numerous applications in the field of agriculture, as a seed coating and/or other uses for the roots, leaves, fruits, etc.

In embodiments, the agricultural composition in accordance with the present invention consists of a seed coating composition which can provide one or more of the following benefits, when compared to uncoated seeds: improving germination rate, increasing water absorption or uptake by the seed, reducing water loss by the seed, increased seedling emergence, increasing root hair formation, allowing germination under reduced humidity conditions (e.g., warm and/or dry conditions where seeds have limited access to water), etc.

In embodiments, the agricultural composition in accordance with the present invention consists of a composition for use on plant leaves, roots, fruits, flowers, etc. For instance, the composition may be applied by any suitable means, either in solid (e.g., as a free-flowing powder), liquid or viscous form (such as a spray). Envisioned techniques comprise leaves spray and root contacting. The composition may also be applied to various portions of the plant, or be provided to the roots or seeds in slow-release formulations, such as beads, granules or gels.

In embodiments, such composition could provide benefits to the plant such as increasing nodule numbers, increasing nitrogen concentration and/or total amount of nitrogen fixation. When applied as a leaf spray, the composition could increase leaf photosynthetic rates, leaf greenness and leaf area. When applied to roots, it could increase photosynthetic rates, increase leaf greenness, increase leaf area and/or increase plant dry matter accumulation.

The agricultural compositions of the invention may be used and the methods of the invention practiced wherever plants are grown, such as in greenhouses, field, or laboratory conditions. The compositions could be used with plants that are grown at temperatures above 30° C., at which temperatures nitrogen fixing rhizobacteria are generally most active, or also at low temperatures, such as at an average daily root zone temperature below 28° C., 26° C., 24° C., 22° C., 20° C., 18° C., 16° C., 14° C., 12° C., or 10° C.

The agricultural compositions and methods of the invention are not limited to use with any particular plant or plant-type. Exemplary plants with which the methods of the invention may be practiced include, without limitation: legumes, such as soybeans, peanuts, pulses (e.g., pea and lentil), bean, forage crops (e.g., alfalfa and clover), plants of lesser agricultural importance (e.g., lupine, sainfoin, trefoil, and even some small tree species); Solanaceae family (e.g., tomato, peppers, eggplants), Cucurbitaceae family (cucumbers, squash, melons), corn; horticultural tree species (e.g., peach, apple, plum, pear, mango), forestry tree species (e.g., spruce, pine, fir, maple, oak, poplar), and small grain cereals such as wheat, barley, oat, and canola.

In embodiments, for seed coating applications, the seed is selected from corn, wheat, soybeans, barley, oat, canola, sunflower, alfalfa, edible beans, grains sorghum, nightshades, squash, cucumbers, melons, turf, forage grass, and peas.

Accordingly, particular aspects of the invention relates to methods of seed coating. In one embodiment the method comprises applying onto seeds the composition as defined herein.

Another related aspect concerns a method of improving germination of a seed during planting. In one embodiment the method comprises coating a seed with a coating composition as defined herein.

Another related aspect concerns a method for delivering one or more bioactive ingredient(s) to a plant. In one embodiment the method comprises applying to the seed(s) a coating composition comprising at least one bioactive ingredient stably dispersed in a biopolymer composition as described herein. In another embodiment the method comprises applying to the roots, tubers, leaves, petals, seeds, and/or fruits, etc. a composition comprising at least one bioactive ingredient stably dispersed in a biopolymer composition as described herein.

The compositions of the present invention may also be useful in the manufacture of fertilizers and also as a fertilizer itself, as and in conditioning agents, as and in plant disease control agents, as and in antitranspirants, as and in ripening retardants, as and in fruit coatings, etc.

Those skilled in the art will recognize, or be able to ascertain, using no more than routine experimentation, numerous equivalents to the specific procedures, embodiments, claims, and examples described herein. Such equivalents are considered to be within the scope of this invention, and covered by the claims appended hereto. The invention is further illustrated by the following examples, which should not be construed as further or specifically limiting.

### EXAMPLES

### Example 1: Seed Coating

Experiments were carried out to evaluate to what extent a seed coating in accordance with the present invention can help to retain water on the seed and improve germination in less humid conditions.

### Seed Coating

Biopolymer suspensions comprising either chitosan, cellulose and chitin were made and used for seed coating. Briefly, coated lentil seeds were produced by adding 10 g of lentils to a 90 mL polypropylene container with 3-3.5 g of any of the biopiolymer suspension (this is in excess). Each of the chitosan, chitin or cellulose suspension was produced with a 1.5 L Supermill Plus™ with 1.4-1.7 mm zirconia beads in a 20 L batch by milling with the general milling conditions of 2400 FPM (feet per minute) rotation speed with a pump flow rate of 7.3 GPH (gallons per hour) using 982 mL of 1.4-1.7 mm zirconia beads, where 20 liters of slurry were processed in a 5% solids content (1.05:20).

The coating was distributed by manual rotational shaking of the container. Visual inspection revealed that the seeds were fully coated with the biopolymer suspension within 2 minutes of shaking and rotating. The coated seeds were spread onto a silicone sheet to dry. Once dried the coated seeds were labelled as coated. The dry coating on 10 g of seeds was approximately 0.12 g of biopolymer.

### Water Uptake Comparison

4 g of each coated and uncoated lentil seeds were added to 15 g of water and allowed to sit for 30 mins to absorb water. After 30 mins, the seeds were sieved out to separate from the water. The wet seeds were then laid onto a paper towel and patted dry briefly to remove surface water.

The seeds were then weighed to measure the amount of water absorbed. Over time, the weight of the seed batch was noted to determine the water loss. Relative humidity of the environment was 35%.

Over the initial 30 mins the uncoated seeds retained ˜1.27 g of water, whereas the coated seeds retained ˜2.20 g of water.

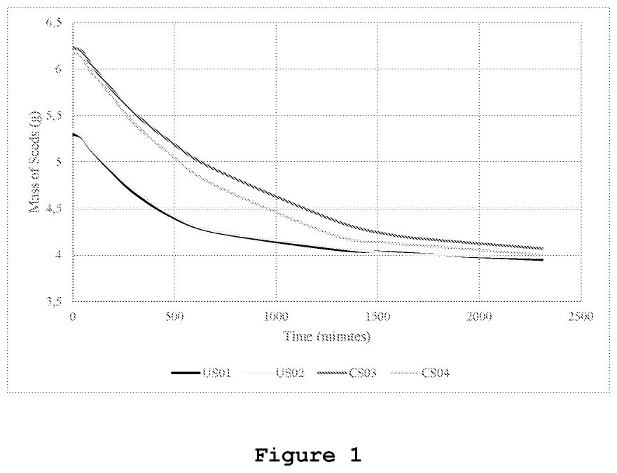

Over time the water loss was measured by weighing the seeds in their petri dish. The increased water absorption of the coated seeds enhanced the water retention duration when compared to uncoated seeds. As shown in FIG. 1, the extra water absorption from the coated seeds (CS03 and CS03) delays drying by approximately 6 hours, where the weight of the coated seeds matches the initial weight of the uncoated seeds (US01 and US02).

### Example 2: Plant Emergence with Chitosan and Bacillin 20

An experiment was carried out to demonstrate the positive of effect of chitosan seed coating on soybean seedling emergence and growth in soil. At 72 hours, seed coated with a composition comprising a combination of chitosan and Bacillin 20 showed an increase in germination rate (73%) over non-coated (62%) and over Bacillin 20 only coated seeds (43%).

### Example 3: Seed Coating with Chitin in Combination with a Bioactive Agent

An experiment was carried out to study the impact of chitin and a bioactive agent (i.e. a microbial peptide having plant biostimulant activity such as Bacillin 20 (ABIO™) on soybean seeds water absorption and seed germination. Significant results were observed for seed germination and root hair formation.

### Water Absorption

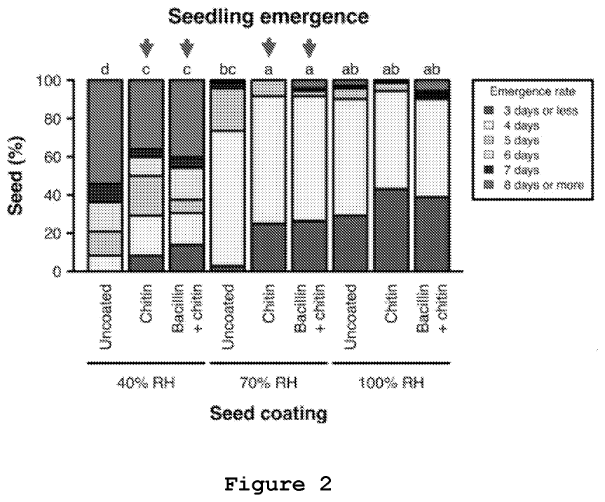

As can be observed on FIG. 2, at a relative humidity level of 40%, after 3 days, none of the uncoated seeds have germinated, chitin coated is about at 8% germination, chitin and bacillin 20 is about at 13% germination. After 5 days, the uncoated germination rate is ˜20% whereas chitin coated is close to 50%. Chitin and Bacillin 20 is close to 38%. At a relative humidity level of 70%, after 3 days, ˜3% of the uncoated seeds have germinated, germination of chitin coated is about 22%, germination of chitin and Bacillin 20 is about 23%. After 4 days, the uncoated germination rate is ˜76% whereas chitin coated is close to 91% as well as germination chitin and bacillin 20 (˜91%). These results demonstrate that coating soybean seeds in chitin (with or without a bioactive agent such as a bacillin 20) accelerates soybean seed germination and plantlet emergence under standard and water-stress conditions.

### Root Hair Formation

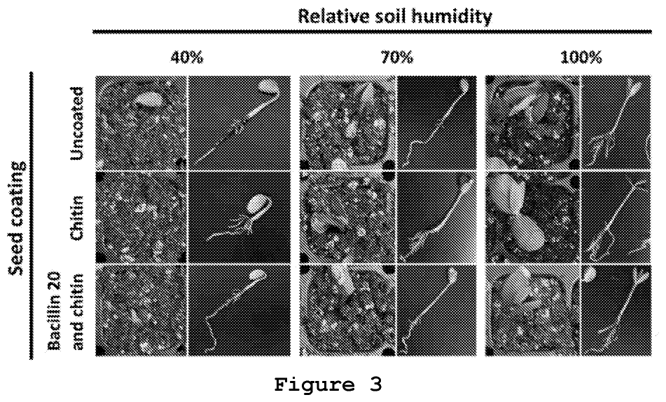

The coating of soybean seeds in chitin (with or without bacillin 20) also significantly enhanced root hair growth as shown in FIG. 3. Briefly, root growth was compared across different relative humidity levels. Relative humidity germination conditions were compared with uncoated, chitin coated and chitin+bacillin 20 coated soybeans. At 100% RH all versions have good root growth and are visually similar. At 70% relative humidity uncoated seeds have few secondary roots grown, chitin coated seeds have significant root growth, similar to that of 100% RH, and the chitin and bacillin 20 coated have less than the chitin alone (but more than the uncoated). At 40% relative humidity, the uncoated seeds have shorter root growth. Chitin coated seeds have similar length main roots with longer secondary roots. Finally, the chitin and bacillin 20 coated seeds had much longer roots at this stage. These results demonstrate that coating soybean seeds in chitin (with or without a bioactive agent (including biopeptides such as a bacillin 20) enhances root hair formation.

Headings are included herein for reference and to aid in locating certain sections. These headings are not intended to limit the scope of the concepts described therein, and these concepts may have applicability in other sections throughout the entire specification. Thus, the present invention is not intended to be limited to the embodiments shown herein but is to be accorded the widest scope consistent with the principles and novel features disclosed herein.

The singular forms “a”, “an” and “the” include corresponding plural references unless the context clearly dictates otherwise. Thus, for example, reference to “a biopolymer” includes one or more of such biopolymers and reference to “the method” includes reference to equivalent steps and methods known to those of ordinary skill in the art that could be modified or substituted for the methods described herein.

Unless otherwise indicated, all numbers expressing quantities of ingredients, reaction conditions, concentrations, properties, and so forth used in the specification and claims are to be understood as being modified in all instances by the term “about”. At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in the specific examples are reported as precisely as possible. Any numerical value, however, inherently contains certain errors resulting from variations in experiments, testing measurements, statistical analyses and such.

It is understood that the examples and embodiments described herein are for illustrative purposes only and that various modifications or changes in light thereof will be suggested to persons skilled in the art and are to be included within the present invention and scope of the appended claims.

1. A seed coating composition comprising a biopolymer, wherein the composition comprises biopolymer molecules that have been mechanically processed into a stable homogeneous aqueous suspension.

2. The seed coating composition according to claim 1, further comprising at least one of a bioactive agent, a safener, a binder, a wax, a stabilizer, a humectant, and a colorant.

3. The seed coating composition according to claim 2, wherein the bioactive agent is selected from the group consisting of fungicides, insecticides, bacterium, biopeptides, nitrogen fixers, low molecular weight biopolymers, and oligomers.

4. The seed coating composition according to claim 1, wherein said seed coating composition is formulated as a paste, an ointment, a cream, a lotion, a gel or a milk.

5. The seed coating composition according to claim 1, wherein the composition comprises an homogeneous aqueous suspension of insoluble and/or semi-soluble biopolymer particles.

6. The seed coating composition according to claim 1, wherein the stable homogeneous aqueous suspension comprises insoluble and/or semi-soluble biopolymer particles stably dispersed within a polar solvent.

7. The seed coating composition according to claim 1, wherein the biopolymer consists of a stable homogeneous aqueous suspension composed of insoluble and/or semi-soluble biopolymer particles.

8. The seed coating composition according to claim 1, wherein the biopolymer is selected from the group consisting of chitin, chitosan, cellulose, hemicellulose, lignin, amylose, actin, fibrin, collagen, silk, fibroin, keratin, wool, alginic acid and mixtures thereof.

9. The seed coating composition according to claim 1, wherein the biopolymer is selected from the group consisting of gelatin, pectin, starch, amylopectin, agarose, alginic acid, alginate, hyaluronic acid, RNA, DNA, xanthan gum, guar gum, latex, polymannans, suberin, cutin, cutan, and mixtures thereof.

10. A seed coated with a seed coating composition as defined in claim 1.

11. The seed of claim 10, wherein the seed is selected from the group consisting of corn, wheat, soybeans, barley, oat, canola, sunflower, alfalfa, edible beans, grains sorghum, nightshades, squash, cucumbers, melons, turf, forage grass, and peas.

12. (canceled)

13. (canceled)

14. (canceled)

15. A method of improving plant emergence, the method comprising: (i) coating a seed to be planted with a coating composition as defined in claim 1 to obtain a coated seed; and (ii) planting said coated seed into soil, wherein said coated seed displays improved germination compared to a non-coated seed.

16. A method for coating a seed with a bioactive ingredient, the method comprising applying to the seed a seed coating composition comprising at least one bioactive ingredient stably dispersed in a biopolymer composition.

17. A composition for use in agriculture, the composition comprising biopolymer molecules that have been mechanically processed into a stable homogeneous aqueous suspension, and wherein said stable homogeneous aqueous suspension comprises insoluble and/or semi-soluble biopolymer particles stably dispersed within a polar solvent.

18. The composition according to claim 17, wherein said composition is formulated for an application to at least one of plant leaves, seeds, roots, fruits, and flowers.

19. The composition according to claim 17, wherein said composition consists of a seed coating, a seed pellet, a fertilizer, a powder, a root dripping solution, and/or a foliar spray.

20. The composition according to claim 17, further comprising at least one of a bioactive agent, a safener, a binder, a wax, a stabilizer, a humectant, and a colorant.

21. The composition according to claim 20, wherein the bioactive agent is selected from the group consisting of fungicides, insecticides, bacterium, biopeptides, nitrogen fixers, low molecular weight biopolymers, and oligomers.

22. The composition according to claim 17, wherein the biopolymer is selected from the group consisting of chitin, chitosan, cellulose, hemicellulose, lignin, amylose, actin, fibrin, collagen, silk, fibroin, keratin, wool, alginic acid and mixtures thereof.

23. (canceled)
